(19) United States
(12) Patent Application Publication
(10) Pub. No.: US 2004/0174272 A1
(43) Pub. Date: Sep. 9, 2004

(54) Electronic tolling system

(76) Inventor: Chin E. Lin, Tainan (TW)

Correspondence Address: BACON & THOMAS, PLLC, 625 SLATERS LANE, FOURTH FLOOR, ALEXANDRIA, VA, 22314

(21) Appl. No.: 10/377,883

(22) Filed: Mar. 4, 2003

(51) Int. Cl. G08G 1/00

(52) U.S. Cl. 340/928

(57) ABSTRACT

An electronic tolling system includes an in-car communicating device in a vehicle, a roadside transmitting unit and a roadside confirm unit positioned in front of a tollbooth, and a toll managing center making two-way communication with the communicating device. The in-car communicating device receives the signal of the transmitting unit and transmits data of the user and the date of transaction to the toll managing center, which then receives and confirms the data and then feeds back a confirm signal. The vehicle transmits the confirm signal to the confirm unit when passing by the confirm unit so as to pass through the tollbooth smoothly. If the confirm unit does not receive the confirm signal from the toll managing center, it starts an automatic photographing system to take picture of the vehicle for an evidence of no toll payment.

### BACKGROUND OF THE INVENTION

1. Field of the Invention

This invention relates to an electronic tolling system, particularly to one tolling online by utilizing mobile communication of signal transmission for recording data from a mobile phone handset without needing workers to collect tolls from vehicles passing through a tollbooth so that vehicles need no cash in passing through a tollbooth, saving human labor, facilitating fast passage of vehicles with convenience.

2. Description of the Prior Art

As conventional highway tollbooths completely employ human labor for tolling passing vehicles, it often happens that drivers throw away receipts at random to make up dirt and garbage on roads, and tollbooths have to pile up a large sum of cash, potentially attracting would-be robbers, receive fake notes carelessly or unintentionally, and need many workers. Besides, a large number of toll tickets have to be printed, and passing vehicles have to slow down speed, often waiting in a long line for passing through a tollbooth.

### SUMMARY OF THE INVENTION

This invention has been devised to offer an electronic tolling system by means of mobile communication, mainly in order to getting rid of the problem of making up garbage by printing a large number of toll receipts, of preparing cash by drivers of vehicles passing through highway tollbooths so as to save human labor, enabling fast passing of vehicles through tollbooths.

The electronic tolling system in the invention includes an in-car communicating device provided in a vehicle, a roadside transmitting unit and a roadside confirming unit respectively positioned at different preset locations in front of a tollbooth, and a toll managing center (TMC) making two-way communication with the in-car communicating device of a vehicle through a designated address of a network.

In operation of the electronic tolling system, a user turns on a mobile phone handset connected to the in-car communication device in advance. When the user passes by the roadside transmitting unit of a tollbooth, the roadside transmitting unit transmits a signal of the data of the tollbooth to the in-car communicating device of the vehicle of the user, and then the mobile phone handset of the user is dialed and connected to the network system of the TMC so that the communicating device of the user may transmit the data of the user, the date of transaction, etc. to TMC. Then after the TMC confirms the data sent by the user as correct, the TMC feeds back a simple signal of the toll completion to the in-car communicating device. Then when the vehicle further runs forward and passes by the roadside confirm unit of the tollbooth, it transmits the simple signal of the, confirm of the toll completion to the confirm unit, which then turns on the green light to let the vehicle pass through the tollbooth. On the other hand, if the confirm unit does not receive the simple signal of the toll completion, the confirm unit controls to turn on the red light and start an automatic photographing system installed in the tollbooth to take picture of the vehicle not paying the toll for an evidence, acquiring the purpose of the invention.

### BRIEF DESCRIPTION OF DRAWINGS

This invention will be better understood by referring to the accompanying drawings, wherein:

FIG. 1 is an upper graphical view of a preferred embodiment of an electronic tolling system in the present invention;

FIG. 2 is a simple view of an in-car communicating device in the present invention;

FIG. 3 is a flow chart of the operation processes of the electronic tolling system in the present invention;

FIG. 4 is a flow chart of tolling processes of the electronic tolling system in the present invention;

FIG. 5 is a diagram of a conventional communicating route to the Internet; and,

FIG. 6 is a diagram of a communication route to the Internet innovated by the present invention.

### DETAILED DESCRIPTION OF THE PREFERRED EMBODIMENT

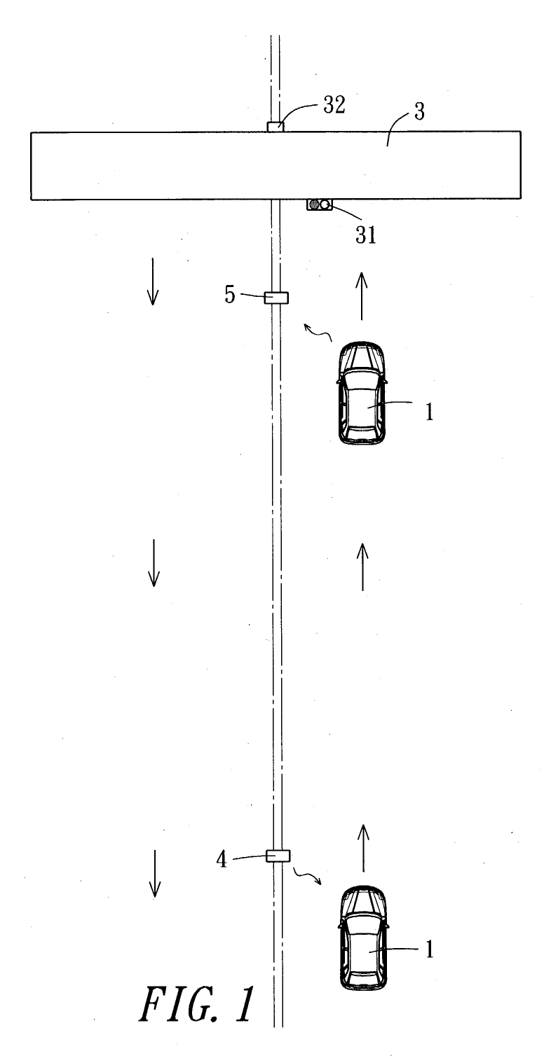

A preferred embodiment of an electronic tolling system in the present invention, as shown FIG. 1, includes an in-car communicating device 2 provided in a vehicle 1, a roadside transmitting unit 4 and a roadside confirm unit 5 respectively positioned at different locations spaced apart in front of a tollbooth 3, and a toll managing center 6 (TMC) making two-way communication with the in-car communicating device 2.

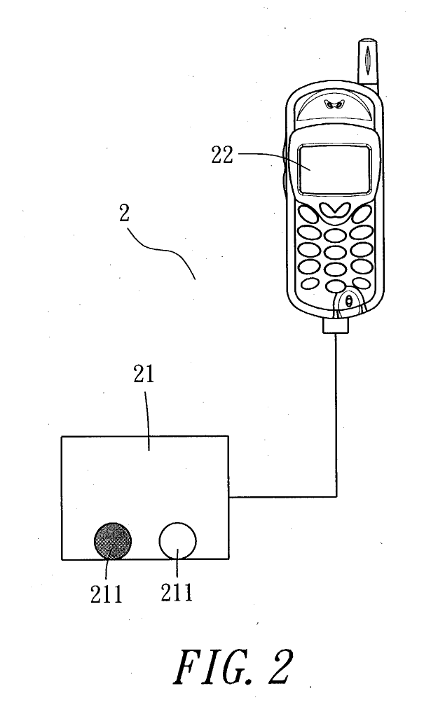

The in-car communicating device 2 shown in FIG. 2, consists a communicating device 21 with two lamps 211 (a red one and green one) located easily discernible in front of a driver's seat, and a mobile phone 22 (a common mobile phone including GSM (Global System for Mobile communications) or GPRS (General Pocket Radio Service) handsets. The mobile phone 22 is provided with a function of getting on a network (if the mobile phone is of the GPRS system, it can directly connect to the Internet). If it is of the GSM system, it needs in advance to connect with an interconnecting station and then is interconnected to the Internet). The communicating device 21 stores in advance the detailed data of the user (such as an ID number, the registered address, a bank account number, a code, an address of the bank, etc.). The communicating device 21 can connect with the TMC 6 of a highway by means of the mobile phone 22.

The roadside transmitting unit 4 and the roadside confirm unit 5 are positioned in front of the entrance of a tollbooth 3, with the roadside transmitting unit 4 being farther from the tollbooth 3 than the confirm unit 5. The transmitting unit 4 stores the detailed data of the tollbooth (such as the name of the tollbooth, etc.). The roadside confirming unit 5 is comparatively nearer to the tollbooth 3, directly controlling traffic signals such as red and green lights and an automatic photographing system provided at the tollbooth 3.

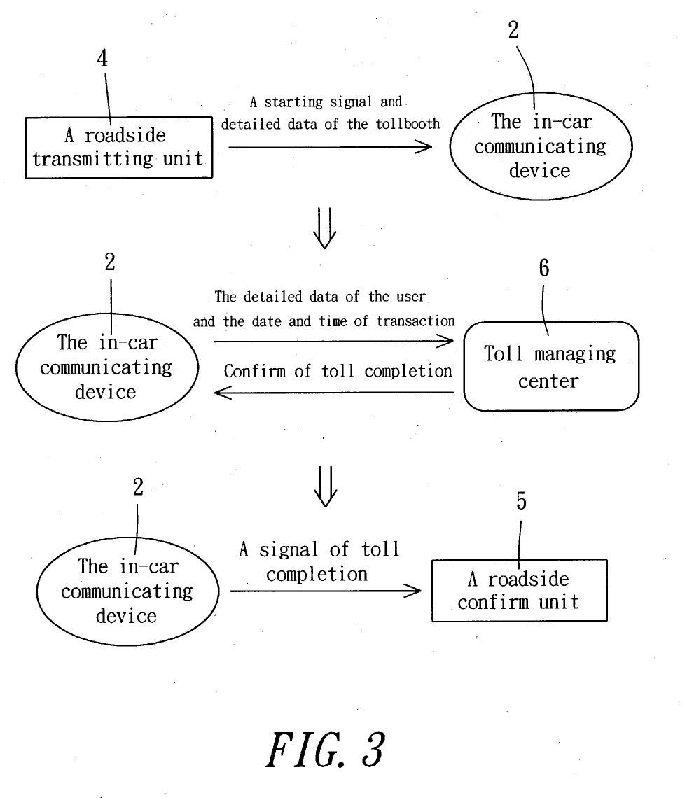

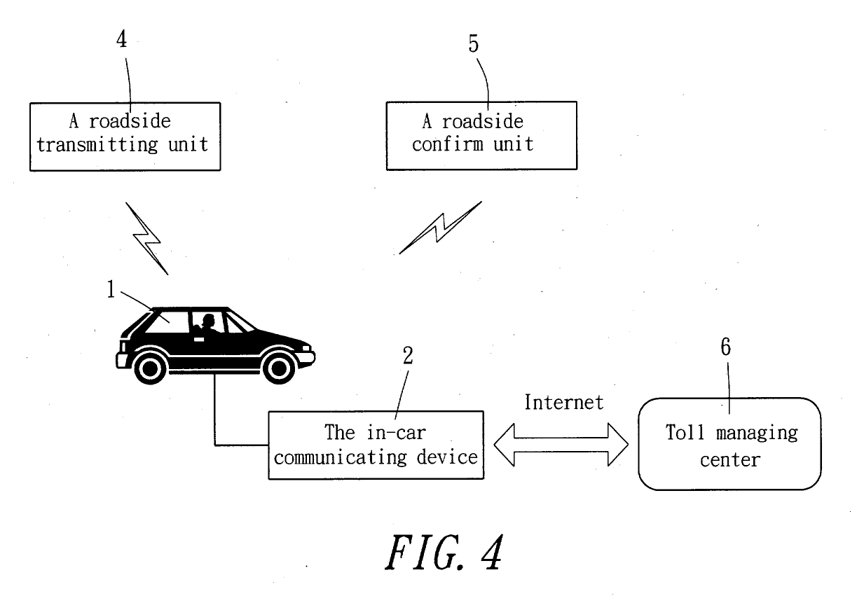

As to the operative process of the electronic tolling system, as shown in FIGS. 3 and 4, at first, when a user driving a vehicle 1 on a highway moves near a tollbooth 3, the vehicle 1 first passes by the transmitting unit 4, which will transmit a tolling signal also including a starting signal and detailed data of the tollbooth 3. Then the in-car communicating device 2 of the user's vehicle 1 receives the tolling signal and starts the mobile phone 22 to dial a number to connect to the Internet through a modem to transmit the detailed data of the user and the date and time of transaction to the TMC 6 through the Internet. After the TMC 6 receives the signal of the user and decides the amount of the toll to be charged according to the detailed data of the communicating device 21 of the user, and stores the detailed data of the user and the date and time of the transaction in a data storage provided in the TMC 6, and then feeds back the signal of toll completion to the in-car communicating device 2 of the vehicle 1. In the next process, the in-car communicating device 2 sends again a signal of toll completion to the confirm unit 5, when the vehicle 1 has reached the confirm unit 5 after receiving the confirm signal from the TMC 6. So the roadside conform unit 5 starts the traffic signal 31 into a passable condition or the green light, permitting the vehicle 1 pass through the tollbooth 3. On the other hand, if the roadside confirm unit 5 does not receive the signal of toll completion of the vehicle 1, the confirm unit 5 decides it as a failure of toll completion and turns on the traffic signal into the red light, and starts the automatic photographing system to take picture of the vehicle 1 for an evidence of no payment of the toll of the tollbooth 3 by the vehicle 1. And then a notice of supplemental payment of the toll is to be sent to the user by the TMC 6.

In case of an unusual condition of large flow of vehicles on a highway or traffic jam or very slow flowing of vehicles, a worker or workers may consider in the tollbooth that the confirm unit 5 has its function not enough, and reduces its scope of acceptance for preventing the signals of toll completion of the confirm unit 5 from not conforming to practical numbers of the vehicles 1 passing through the tollbooth 3. Therefore, in case of severe traffic jam and stoppage of vehicle flow, a worker may be dispatched to stand out of the tollbooth for checking the green and red light 211 of the in-car communicating device 21 of the passing vehicles 1 to know if the toll is paid or not.

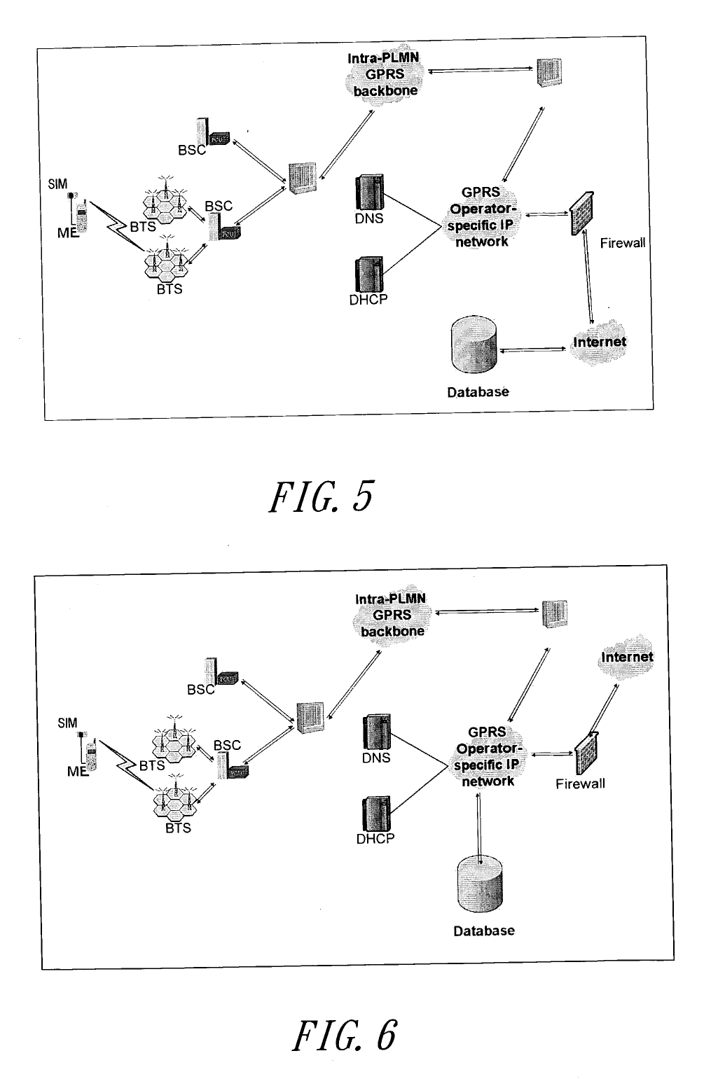

In order to prevent the TMC 6 from being crowded by too large a number of drivers using the electronic tolling system or preventing the data of toll payers from being stolen, a conventional mobile signal transmitting method shown in FIG. 5 is used, letting an external signal enter the input through Intra-PLMN GPRS Backbone and to the servers of the GPRS (GPRS Operator-specific IP Network), passing through a Fire Wall for prevention of database from being stolen and then getting on Internet and then storing data by Internet. The electronic tolling system in the invention employs, in order to improve the drawback of the conventional mobile signal transmitting method shown in FIG. 5, a method shown in FIG. 6, letting the mobile communication signal transmitting network have its external signal inputted in the server of Intra-PLMN Network through the GPRS (GPRS Operator-specific IP Network) via a Fire Wall into Internet. And the database is preserved in a special serving computer installed on the server of GPRS. Thus the speed of receiving data of Internet is elevated, and at the same time the stored data is guaranteed not to be stolen.

It is evident that the electronic tolling system in the invention can be operated without human labor, saving a large expense for workers needed in the conventional toll collecting method for the tollbooths on a highway. As to the toll-collecting mode, a periodical bill of toll records such as for every month can be made and sent to all users by the TMC 6 or authorized private agents. Thus the problems of preparing cash or toll tickets in advance in running on a highway, of too much cash accumulated in the tollbooths, of potent possibility of receiving fake banknotes, of random throwing-away of toll receipts, etc., can be solved. Therefore, the electronic tolling system in the invention can save workforce and reduce the cost needed in managing a highway.

While the preferred embodiment of the invention has been described above, it will be recognized that various modifications may be made therein and the appended claimed are intended to cover all such modifications that may fall within the spirit and scope of the invention.

What is claimed is:

1. An electronic tolling system comprising an in-car communicating device provided in a vehicle and a roadside transmitting unit and a roadside confirm unit installed spaced apart in front of a tollbooth on a highway, said roadside transmitting unit located farther from said tollbooth than said confirm unit, and a toll managing center making two-way communication with a mobile phone handset connected to said in-car communicating device;
Said roadside transmitting unit transmitting a signal of the start of transmission and the data of said tollbooth to said in-car communicating device when said vehicle passing by said roadside transmitting unit, said in-car communicating device transmitting the data of a user and the date and time of the transaction to said toll managing center, said toll managing center receiving and conforming said data from said in-car communicating device and feeding back to said in-car communicating device the signal of the toll confirm, said in-car communicating device transmitting the signal of the toll confirm to said roadside confirm unit when said vehicle passes by said roadside confirm unit, said roadside confirm unit then controlling said tollbooth to let the vehicle pass through; and,
Said roadside conform unit controlling a red traffic light to turn on and an automatic photographing system installed in said tollbooth to start to take picture of the vehicle passing as an evidence of no toll payment in case of said roadside confirm unit not receiving the signal of toll confirm,

2. The electronic tolling system as claimed in claim 1, wherein said in-car communicating device includes a communicating device and a mobile phone connected to said communicating device, and said mobile phone has a designated function of getting on a network.

3. The electronic tolling system as claimed in claim 1, wherein said tollbooth has a passageway installed with traffic signals connected to said roadside confirm unit, said confirm unit controls to turn on a green light of said traffic signals if tolling is completed, and said confirm unit controls to turn on a red light of said traffic signals if tolling is not completed.

4. The electronic tolling system as claimed in claim 1, wherein mobile communication network data transmitting between said in-car communicating device and said toll managing center is effected by inputting external signals in Intra PLMN GPRS Backbone through a server of GPRS (GPRS Operator-specific IP Network), and through a Fire Wall into Internet, and the database is preserved in a serving computer installed on the server of the GPRS so as to elevate the speed of data receiving, and at the same time the data is guaranteed not to be stolen .
